(19) United States
(12) Patent Application Publication
(10) Pub. No.: US 2009/0133011 A1
(43) Pub. Date: May 21, 2009

(54) Automatic updating method

(75) Inventor: Wen-Chu Weng, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/292,358

(22) Filed: Nov. 18, 2008

(30) Foreign Application Priority Data
Nov. 19, 2007 (TW) 96143757

(51) Int. Cl. G06F 9/44

(52) U.S. Cl. 717/168

(57) ABSTRACT

An automatic updating method is applied to an electronic device storing an operating system. The operating system includes a first header. The electronic device is electrically connected to a memory device selectively. The automatic updating method includes the following steps. First, whether the electronic device is electrically connected to the memory device is nonstop determined. Then, when the electronic device is electrically connected to the memory device, whether an updating file is stored in the memory device is determined. After that, when the updating file is stored in the memory device, a second header of the updating file is read. Then, whether the first header and the second header are identical is determined. After that, when the first header and the second header are not identical, the updating file is read to update the operating system.

This application claims the benefit of Taiwan application Serial No. 96143757, filed Nov. 19, 2007, the subject matter of which is incorporated herein by reference.

### BACKGROUND OF THE INVENTION

1. Field of the Invention

The invention relates in general to an updating method, and more particularly to an automatic updating method of a hand-held device.

2. Description of the Related Art

In order to have more additional functions, electronic devices nowadays are usually installed with different kinds of software. Manufacturers often offer updating files for users to update their software because of adding or correcting additional functions of the software.

Generally speaking, when a user updates software, a transmission cable is needed to connect an electronic device with a computer to download an updating file from the computer. At this time, the user has to check if the updating file is the version he/she needs by oneself. Then, after checking, the user has to search for a location to save the updating file to replace the original file for updating the software.

The conventional method limits the user to being around the computer for updating the software and the conventional method is also more time-consuming.

### SUMMARY OF THE INVENTION

The invention is directed to an automatic updating method for automatically updating an operating system of an electronic device. Therefore, the required time to update the operating system is reduced, and it is more convenient to update the operating system.

According to a first aspect of the present invention, an automatic updating method applied to an electronic device is provided. An operating system is stored in the electronic device and includes a first header. The electronic device is electrically connected to a memory device selectively. The automatic updating method includes the following steps. First, whether the electronic device is electrically connected to the memory device is nonstop determined. Next, when the electronic device is electrically connected to the memory device, whether an updating file is stored in the memory device is determined. Afterwards, when the updating file is stored in the memory device, a second header of the updating file is read. Then, whether the first header and the second header are identical is determined. After that, when the first header and the second header are not identical, the updating file is read to update the operating system.

The invention will become apparent from the following detailed description of the preferred but non-limiting embodiments. The following description is made with reference to the accompanying drawings.

### BRIEF DESCRIPTION OF THE DRAWINGS

FIG. 1 illustrates a memory device electrically connected to the electronic device;

FIG. 2 is a flow chart of the automatic updating method according to a preferred embodiment of the present invention;

FIG. 3A is a flow chart illustrating steps of determining whether the updating file is stored in the memory device;

FIG. 3B is a flow chart illustrating the steps of checking whether the filename of the operating system is identified with the filename of one of the files in the memory device;

FIG. 4A illustrates the first header of the operating system;

FIG. 4B illustrates the second header of the updating file;

FIG. 5A is a flow chart illustrating steps of determining whether the first header and the second header are identical;

FIG. 5B is another flow chart illustrating steps of determining whether the first header and the second header are identical;

FIG. 6 is a flow chart illustrating steps of updating the operating system by the updating file; and

FIG. 7 illustrates the to-be-confirmed message.

### DETAILED DESCRIPTION OF THE INVENTION

An automatic updating method of the present embodiment is applied to an electronic device, such as a personal digital assistance phone (PDA phone). An operating system is stored in the electronic device and includes a first header. In addition, a file allocation table (FAT) is stored in the electronic device and a location of the first header and a location of the operating system are recorded in the file allocation table, for example.

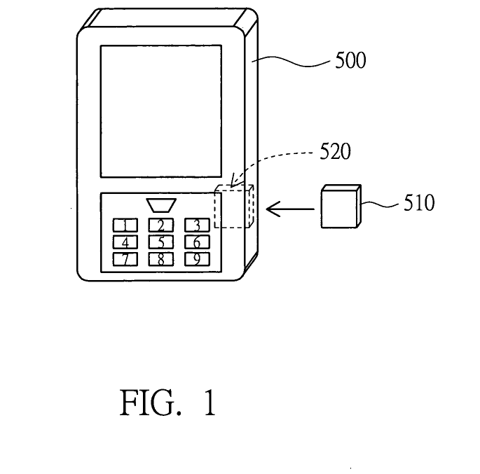

Please refer to FIG. 1. FIG. 1 illustrates a memory device electrically connected to the electronic device. The electronic device 500 is electrically connected to the memory device 510 selectively. The memory device 510 is, for example, a secure digital memory card, a mini secure digital memory card or a multi media card. The memory device 510 is electrically connected to the electronic device 500 by inserting into a socket 520 of the electronic device 500, for example. However, the present invention is not limited thereto. As long as the memory device 510 can cooperate with the electronic device 500, the present invention encompasses such modification.

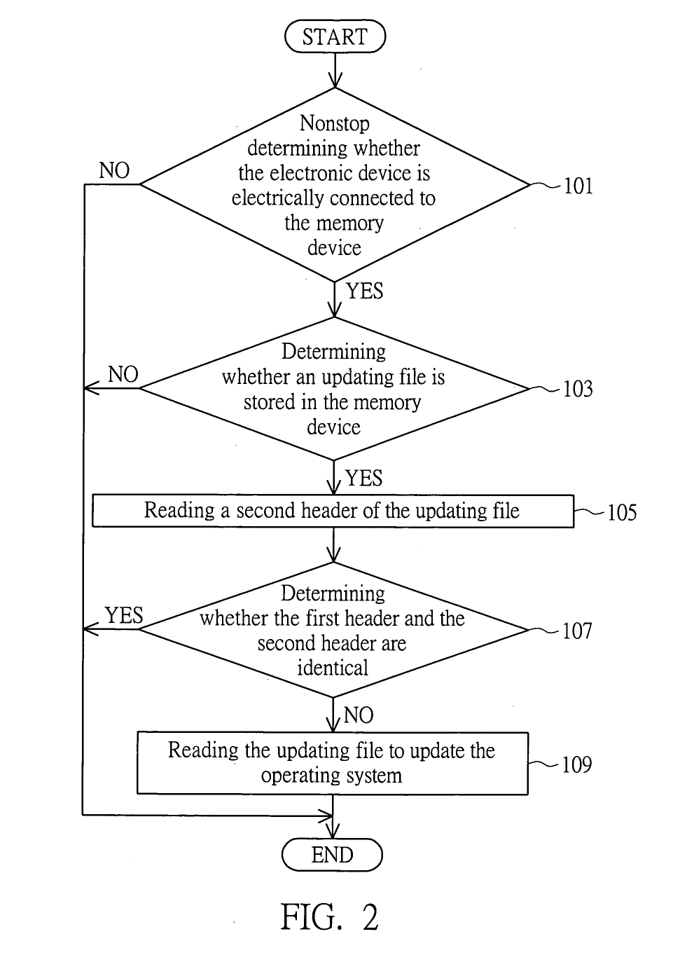

Please refer to FIG. 2 at the same time. FIG. 2 is a flow chart of the automatic updating method according to a preferred embodiment of the present invention. The flow chart of the automatic updating method illustrated in FIG. 2 is an exemplification. Anyone who has ordinary skill in the field can understand that the automatic updating method is not limited to the steps or the order of the steps in FIG. 2, which can be modified or amended according to practical conditions.

First, in the step 101, whether the electronic device 500 is electrically connected to the memory device 510 is nonstop determined. When the electronic device 500 is electrically connected to the memory device 510, the step 103 is then performed. When the electronic device 500 is not electrically connected to the memory device 510, the automatic updating method ends.

In the step 103, whether an updating file is stored in the memory device 510 is determined. When the updating file is stored in the memory device 510, the step 105 is then performed. When no updating file is stored in the memory device 510, the automatic updating method ends.

In the step 105, a second header of the updating file is read. In the present embodiment, a file allocation table (FAT) is stored in the memory device 510, for example. A location of the second header and a location of the updating file are stored in the file allocation table of the memory device 510. Therefore, the second header is read from the location stored in the file allocation table of the memory device 510 in the step 105.

Then, in the step 107, whether the first header and the second header are identical is determined. When the first header and the second header are not identical, the step 109 is then performed. When the first header and the second header are identical, the automatic updating method ends.

In the step 109, the updating file is read to update the operating system. As a result, the operating system of the electronic device 500 is updated automatically, which reduces the time to update the operating system. Furthermore, compared to the conventional updating method of the operating system, performing the automatic updating method of the present embodiment is more convenient.

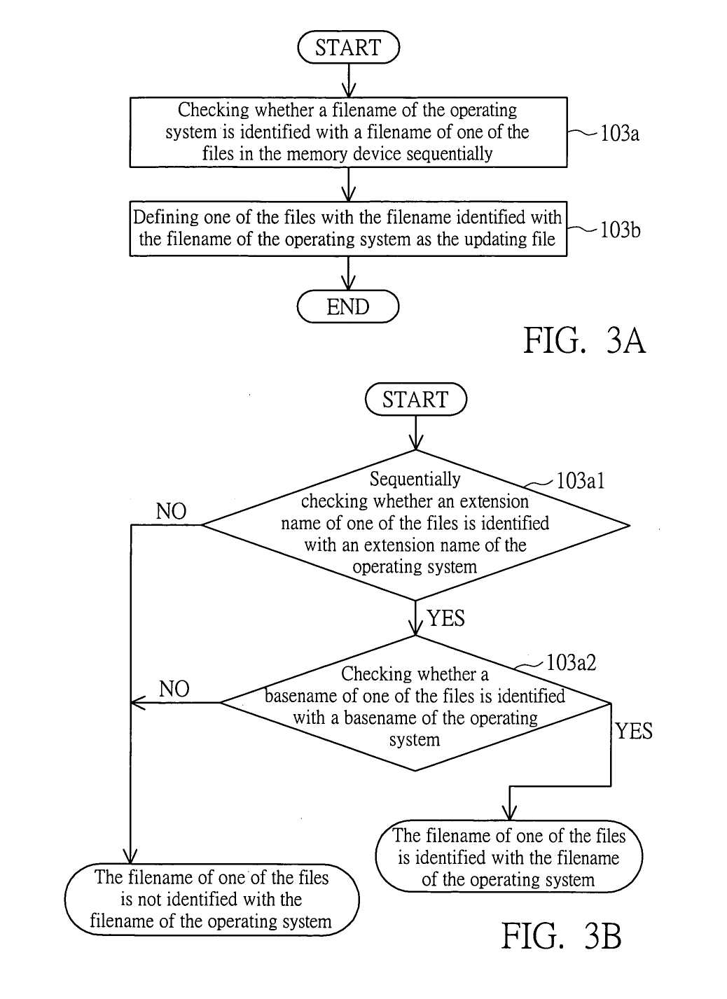

The automatic updating method is further described as follow. Please refer to FIG. 3A. FIG. 3A is a flow chart illustrating steps of determining whether the updating file is stored in the memory device. The step 103 in FIG. 2 includes the steps 103a and 103b shown in FIG. 3A. First, in the step 103a, whether a filename of the operating system is identified with a filename of one of the files in the memory device 510 is checked sequentially. Next, in the step 103b, one of the files with the filename identified with the filename of the operating system is defined as the updating file, so that the step 105 (in FIG. 2) of reading the second header of the updating file can be subsequently performed.

The step 103a in FIG. 3A includes steps 103a1 and 103a2 in FIG. 3B. Please refer to FIG. 3B. FIG. 3B is a flow chart illustrating the steps of checking whether the filename of the operating system is identified with the filename of one of the files in the memory device. First, in the step 103a1, whether an extension name of one of the files is identified with an extension name of the operating system is checked sequentially. When the extension name of one of the files is not identified with the extension name of the operating system, it is determined that the filename of one of the files is not identified with the filename of the operating system, and the automatic updating method ends. When the extension name of one of the files is identified with the extension name of the operating system, the step 103a2 is then performed.

In the step 103a2, whether a basename of the one of the files is identified with a basename of the operating system is checked. When the basename of one of the files is identified with the basename of the operating system, the filename of one of the files is identified with the filename of the operating system and the step 103b in FIG. 3A is then performed. When the basename of one of the files is not identified with the basename of the operating system, it is determined that the filename of one of the files is not identified with the filename of the operating system, and the automatic updating method ends.

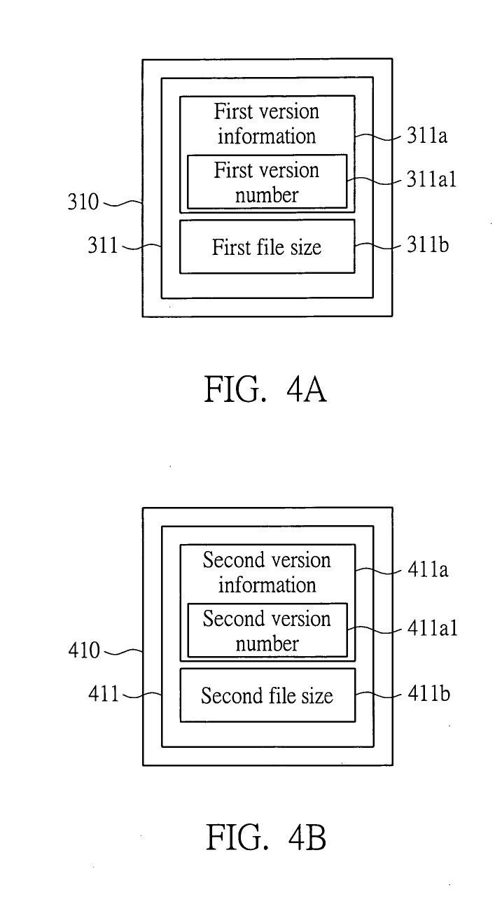

Please refer to FIG. 4A and FIG. 4B respectively. FIG. 4A illustrates the first header of the operating system. FIG. 4B illustrates the second header of the updating file. As shown in FIG. 4A, the first header 311 of the operating system 310 includes, for example, a first version information 311a and a first file size 311b. The first version information 311a includes a first version number 311a1, for example. As shown in FIG. 4B, the second header 411 of the updating file 410 includes a second version information 411a and a second file size 411b, for example. The second version information 411a includes a second version number 411a1, for example. The above-described information of the first header 311 and the second header 411 are used for determining whether the first header 311 is identical with the second header 411 (the step 107 in FIG. 2). However, the present invention is not limited thereto. Whether the first header 311 and the second header 411 are identical can also be determined by checking other information of the first header 311 and the second header 411.

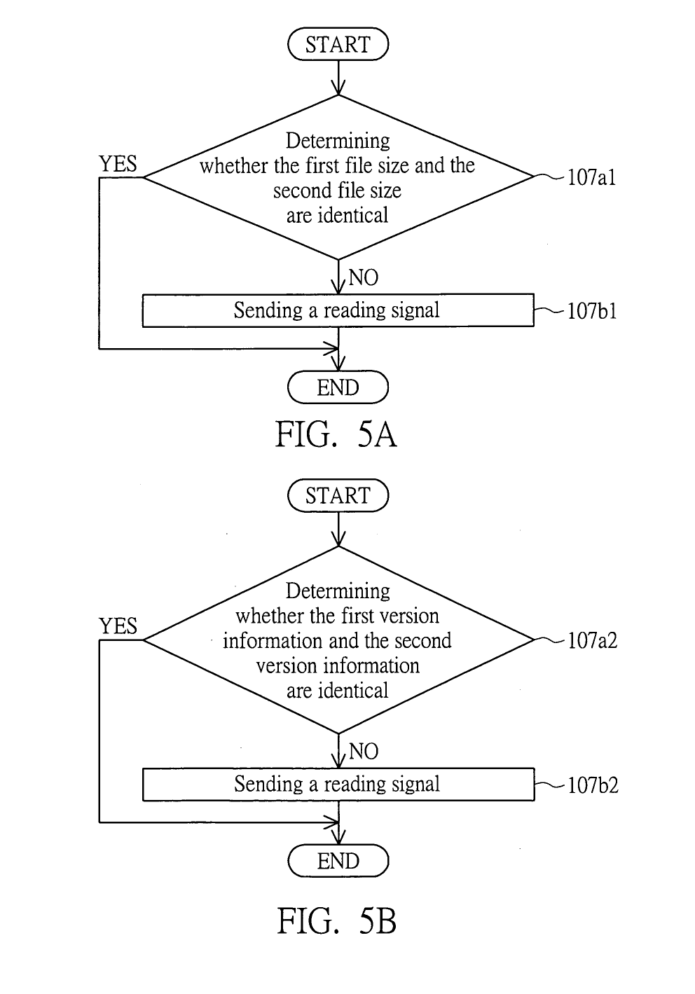

Please refer to FIG. 5A at the same time. FIG. 5A is a flow chart illustrating steps of determining whether the first header and the second header are identical. Whether the first header 311 and the second header 411 are identical is determined by checking the first file size 311b of the first header 311 with the second file size 411b of the second header 411. The step 107 (as shown in FIG. 2) includes the steps 107a1 and 107b1. In the step 107a1, whether the first file size 311b and the second file size 411b are identical is determined. When the first file size 311b and the second file size 411 b are identical, the first header 311 and the second header 411 are identical and the automatic updating method ends. When the first file size 311b and the second file size 411b are not identical, the first header 311 and the second header 411 are not identical. Then, the step 107b1 is performed to send a reading signal for reading the updating file 410 (the step 109 in FIG. 2).

Of course, whether the first header 311 and the second header 411 are identical can be determined by checking if the first version information 311a of the first header 311 and the second version information 411a of the second header 411 are identical. Please further refer to FIG. 5B. FIG. 5B is another flow chart illustrating steps of determining whether the first header and the second header are identical. The step 107 (as shown in FIG. 2) includes the steps 107a2 and 107b2. In the step 107a2, whether the first version information 311a and the second version information 411a are identical is determined. When the first version information 311a and the second version information 411a are identical, the first header 311 and the second header 411 are identical and the automatic updating method ends. When the first version information 311a and the second version information 411a are not identical, the first header 311 and the second header 411 are not identical. Then, in the step 107b2, a reading signal is sent for reading the updating file 410 (the step 109 in FIG. 2).

The steps in FIG. 5A and FIG. 5B are used for determining whether the first header 311 and the second header 411 are identical by checking the different information respectively. Of course, the steps in FIG. 5A and FIG. 5B of determining whether the first header 311 and the second header 411 are identical can also be combined. Or, other information of the first header 311 and the second header 411 can also be used for determining whether the first header 311 and the second header 411 are identical.

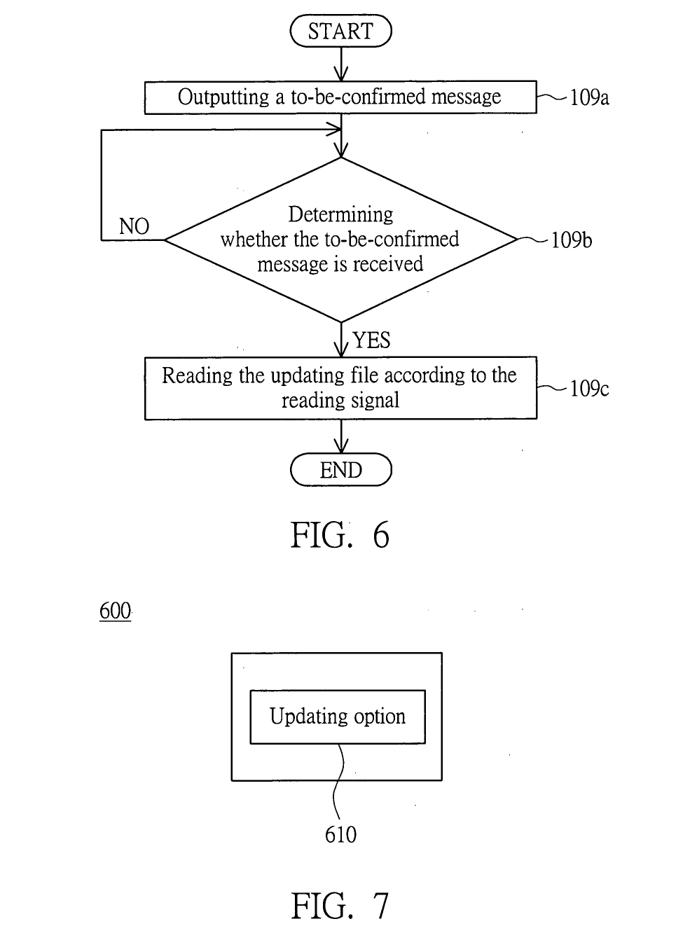

Please refer to FIG. 6. FIG. 6 is a flow chart illustrating steps of updating the operating system by the updating file. The step 109 in FIG. 2 includes the steps 109a, 109b and 109c in FIG. 6. A to-be-confirmed message is output in the step 109a. Please refer to FIG. 7 at the same time. FIG. 7 illustrates the to-be-confirmed message. The to-be-confirmed message 600 includes an updating option 610 for a user to select. Next, in the step 109b, whether the to-be-confirmed message 600 is received is determined. In other words, whether the user selects the updating option 610 is determined. Then, in the step 109c, when the to-be-confirmed message 600 is received, that is, when the user selects the updating option 610, the updating file 410 is read according to the reading signal. Accordingly, the operating system 310 of the electronic device 500 is updated.

In the automatic updating method of the above embodiment, the operating system of the electronic device is updated automatically. The steps of the automatic updating method includes automatic searching for the updating file, automatic checking the updating file with the original file and automatic replacing the original file with the updating file. Therefore, compared to the conventional updating method, the automatic updating method of the present invention is less time-consuming and more convenient.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic updating method applied to an electronic device storing an operating system, the operating system comprising a first header, the electronic device electrically connected to a memory device selectively, the automatic updating method comprising:
nonstop determining whether the electronic device is electrically connected to the memory device;
determining whether an updating file is stored in the memory device when the electronic device is electrically connected to the memory device;
reading a second header of the updating file when the updating file is stored in the memory device;
determining whether the first header and the second header are identical; and
reading the updating file to update the operating system when the first header and the second header are not identical.

2. The automatic updating method according to claim 1, wherein the step of determining whether the updating file is stored in the memory device comprises:
checking whether a filename of the operating system is identified with a filename of one of the files in the memory device sequentially; and
when the filename of one of the files is identified with the filename of the operating system, defining one of the files with the filename identified with the filename of the operating system as the updating file.

3. The automatic updating method according to claim 2, wherein the step of checking whether the filename of the operating system is identified with the filename of one of the files in the memory device sequentially comprises:
sequentially checking whether an extension name of one of the files is identified with an extension name of the operating system; and
when the extension name of one of the files is identified with the extension name of the operating system, checking whether a basename of one of the files is identified with a basename of the operating system;
wherein it is determined the filename of one of the files is identified with the filename of the operating system when the basename of one of the files is identified with the basename of the operating system.

4. The automatic updating method according to claim 1, wherein the first header comprises a first file size, the second header comprises a second file size, and the step of determining whether the first header and the second header are identical comprises:
determining whether the first file size and the second file size are identical; and
sending a reading signal when the first file size is not identical with the second file size.

5. The automatic updating method according to claim 1, wherein the first header comprises a first version information, the second header comprises a second version information, and the step of determining whether the first header and the second header are identical comprises:
determining whether the first version information is identical with the second version information; and
sending a reading signal when the first version information is not identical with the second version information.

6. The automatic updating method according to claim 5, wherein the first version information and the second version information comprise a first version number and a second version number respectively.

7. The automatic updating method according to claim 5, wherein the step of reading the updating file to update the operating system comprises:
outputting a to-be-confirmed message;
determining whether the to-be-confirmed message is received; and
reading the updating file according to a reading signal when the to-be-confirmed message is received.

8. The automatic updating method according to claim 7, wherein the to-be-confirmed message comprises an updating option for a user to select.

9. The automatic updating method according to claim 1, wherein the memory device is a secure digital memory card, a mini secure digital memory card or a multi media card.

10. The automatic updating method according to claim 1, wherein the electronic device comprises a file allocation table (FAT) recording a location of the first header and a location of the operating system.

11. The automatic updating method according to claim 1, wherein the memory device comprises a file allocation table recording a location of the second header and a location of the updating file.
